(19) United States
(12) Patent Application Publication
(10) Pub. No.: US 2013/0265288 A1
(43) Pub. Date: Oct. 10, 2013

(54) Liquid Crystal Display Device and Methods of Operating the Same

(71) Applicant: SAMSUNG ELECTRONICS CO., LTD., Suwon-si (KR)

(72) Inventors: Sooyoung Woo, Suwon-si (KR); Ji Haeng Lee, Seoul (KR); Choonsik Jung, Yongin-si (KR)

(73) Assignee: Samsung Electronics Co., Ltd., Suwon-si (KR)

(21) Appl. No.: 13/857,222

(22) Filed: Apr. 5, 2013

(30) Foreign Application Priority Data
Apr. 5, 2012 (KR) 10-2012-0035557
Aug. 27, 2012 (KR) 10-2012-0093844

(51) Int. Cl. G09G 3/36

(52) U.S. Cl. CPC G09G 3/3614
USPC 345/209; 345/96

(57) ABSTRACT

A liquid crystal display device is provided which includes a gate driver, a source driver, and a timing controller. The timing controller classifies an image signal and generates a gate control signal and a data control signal such that a liquid crystal panel is driven in an inversion manner corresponding to the classifying result.

### CROSS-REFERENCE TO RELATED APPLICATIONS

A claim for priority under 35 U.S.C. §119 is made to Korean Patent Application Nos. 10-2012-0035557 filed Apr. 5, 2012 and 10-2012-0093844 filed Aug. 27, 2012, in the Korean Intellectual Property Office, the entire contents of which are hereby incorporated by reference.

### BACKGROUND

The inventive concepts described herein relate to a liquid crystal display device and a driving method thereof.

A liquid crystal display (LCD) may be applied to various fields as a plate panel type of display device instead of a cathode ray tube (CRT). An active TFT-LCD (Thin Film Transistor-Liquid Crystal Display) with a wide viewing angle and a clear image quality may be used where a thin film transistor may be used as a switching element.

To implement the active TFT-LCD, a liquid crystal may be injected between a glass substrate, on which a thin film transistor array is formed, and a glass substrate on which a color filter is formed. If a voltage signal is applied to the liquid crystal, arrangement of liquid crystal molecules may be changed. This may cause a variation in the orientation of liquid crystals. The active TFT-LCD may generate an image by controlling optical transmittance according to the orientation of liquid crystals.

If a DC voltage is continuously applied to liquid crystals in the same direction during operation of the active TFT-LCD, the orientation of liquid crystals may be fixed in one direction due to a polarization phenomenon of the liquid crystals. This may mean that the image quality can be lowered. To address this problem, the polarity of a reference voltage can be periodically inverted (using an AC voltage signal) as a voltage across a liquid crystal. Periodic inverting of the voltage, however, can cause an increase in the switching frequency, and the power consumption of the liquid crystal display device may increase.

### SUMMARY

One aspect of embodiments of the inventive concept is directed to provide a liquid crystal display device comprising a gate driver configured to drive a gate line of a liquid crystal panel in response to a gate control signal; a source driver configured to drive a data line of a liquid crystal panel in response to a data control signal; and a timing controller configured to generate the gate control signal and the data control signal, wherein the timing controller classifies an image signal and generates the gate control signal and the data control signal such that the liquid crystal panel is driven in an inversion manner corresponding to the classifying result.

In example embodiments, the timing controller classifies the image signal according to a quality sensitivity of the image signal.

In example embodiments, the timing controller generates a mode signal according to quality sensitivity of the image signal and selects an inversion manner of the liquid crystal panel in response to the mode signal.

In example embodiments, when the mode signal is changed, the timing controller changes the inversion manner of the liquid crystal panel in synchronization with a frame.

In example embodiments, when the mode signal is changed, the timing controller changes the inversion manner of the liquid crystal panel in a dimming manner.

In example embodiments, an inversion manner corresponding to the classifying result of the image signal includes an inversion manner where a frame driven in a second inversion manner is inserted in a frame of the liquid crystal panel driven in a first inversion manner.

In example embodiments, an insertion frequency of the frame driven in the second inversion manner is changed according to the classifying result of the image signal.

Another aspect of embodiments of the inventive concept is directed to provide a liquid crystal display device driving method comprising classifying an image signal according to a quality sensitivity; and changing an inversion manner of a liquid crystal panel according to the classifying result of the image signal.

In example embodiments, the liquid crystal display device driving method further comprises allowing a host to generate a mode signal according to the classifying result of the image signal. The changing an inversion manner of a liquid crystal panel according to the classifying result of the image signal includes changing an inversion manner of the liquid crystal panel according to the mode signal.

In example embodiments, an inversion manner of the liquid crystal panel includes an inversion manner where a frame driven in a second inversion manner is inserted in a frame of the liquid crystal panel driven in a first inversion manner, and an insertion frequency of the frame driven in the second inversion manner is changed according to the classifying result of the image signal.

Still another aspect of embodiments of the inventive concept is directed to provide a liquid crystal display device comprising a gate driver configured to drive a gate line of a liquid crystal panel in response to a gate control signal; a source driver configured to drive a data line of a liquid crystal panel in response to a data control signal; and a timing controller configured to generate the gate control signal and the data control signal, wherein the timing controller controls the gate driver and the source driver through the gate control signal and the data control signal such that a frame driven in a second inversion manner is inserted in a frame of the liquid crystal panel driven in a first inversion manner.

In example embodiments, the liquid crystal display device further comprises a sensor configured to measure a driving state and to compare the measured driving state with a predetermined condition to output a comparison signal. An insertion frequency of the frame driven in the second inversion manner is changed according to the comparison signal.

In example embodiments, the timing controller comprises a register to store at least one or more hybrid frequencies, and the timing controller selects one of the at least one or more hybrid frequencies to use the selected hybrid frequency as the insertion frequency.

In example embodiments, the liquid crystal display device further comprises a nonvolatile memory. The timing controller stores the selected hybrid frequency at the nonvolatile memory in response to the comparison signal.

In example embodiments, the driving state corresponds to an image quality of the liquid crystal panel or a power consumption of the liquid crystal display device.

In some embodiments, a liquid crystal display (LCD) device can include a controller circuit that can be configured to alternate between at least two different data inversion patterns each controlling data values provided to directly adjacent capacitors in an LCD panel.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a liquid crystal display device according to an embodiment of the inventive concept;

FIG. 2 is a diagram illustrating pixel polarities according to a hybrid inversion manner of the inventive concept;

FIG. 3 is a timing diagram of gate and data signals applied to a liquid crystal display device of FIG. 2;

FIG. 4 is a diagram illustrating pixel polarities of a liquid crystal display device driven by a driving method according to another embodiment of the inventive concept;

FIG. 5 is a block diagram schematically illustrating a liquid crystal display device according to another embodiment of the inventive concept;

FIG. 6 is a block diagram schematically illustrating a liquid crystal display device according to still another embodiment of the inventive concept;

FIG. 7 is a block diagram schematically illustrating a host connected with a liquid crystal display device according to an embodiment of the inventive concept;

FIG. 8 is a block diagram schematically illustrating an image classifying unit according to an embodiment of the inventive concept;

FIG. 9 is a table illustrating an image signal of a frame;

FIG. 10 is a table illustrating a contrast signal generated from an image signal of FIG. 9;

FIG. 11 is a table illustrating a histogram generated from a contrast signal of FIG. 10;

FIG. 12 is a block diagram schematically illustrating a liquid crystal display device according to still another embodiment of the inventive concept;

FIG. 13 is a block diagram schematically illustrating a liquid crystal display device according to still another embodiment of the inventive concept;

FIG. 14 is a block diagram schematically illustrating a liquid crystal display device according to still another embodiment of the inventive concept;

FIG. 15 is a diagram schematically illustrating a hybrid frequency loading and storing method of FIG. 14;

FIG. 16 is a flow chart illustrating a liquid crystal display device driving method according to an embodiment of the inventive concept;

FIG. 17 is a flow chart illustrating a liquid crystal display device driving method according to another embodiment of the inventive concept; and

FIG. 18 is a flow chart illustrating a liquid crystal display device driving method according to still another embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when an element is referred to as being “between” two elements, it can be the only element between the two elements, or one or more intervening elements may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element is referred to as being “on”, “connected to”, “coupled to”, or “adjacent to” another element, it can be directly on, connected, coupled, or adjacent to the other element, or intervening elements may be present. In contrast, when an element is referred to as being “directly on,” “directly connected to”, “directly coupled to”, or “immediately adjacent to” another element, there are no intervening elements present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

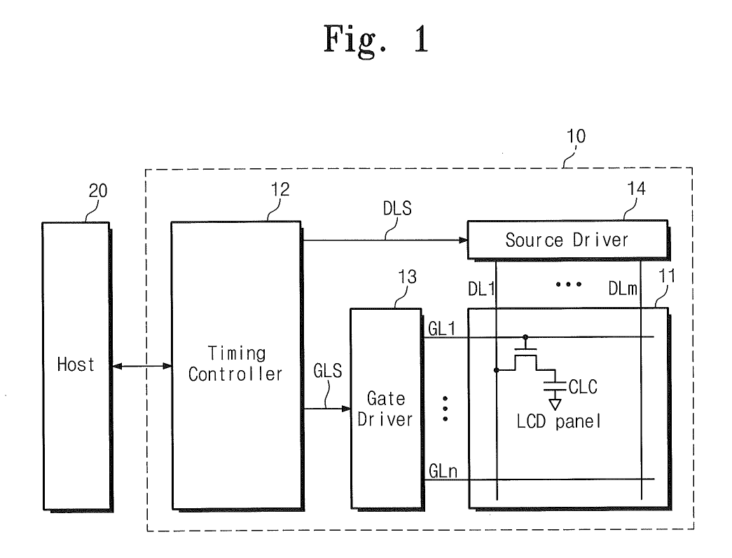

FIG. 1 is a block diagram schematically illustrating a liquid crystal display device according to an embodiment of the inventive concept. Referring to FIG. 1, a liquid crystal display device 10 may include a liquid crystal panel 11, a timing controller 12, a gate driver 13, and a source driver 14.

The liquid crystal panel 11 may include a plurality of gate lines GL1 to GLn, a plurality of data lines DL1 to DLm, and a plurality of pixels arranged at intersections of the gate lines GL1 to GLn and the data lines DL1 to DLm.

The pixels may have the same structure and function. For ease of description, in FIG. 1, one pixel is illustrated. Each pixel may include a thin film transistor and a liquid crystal capacitor CLC. A gate electrode of the thin film transistor may be connected to a corresponding gate line. A source electrode of the thin film transistor may be connected to a corresponding data line. The liquid crystal capacitor CLC may be connected to a drain electrode of the thin film transistor.

The timing controller 12 may receive an external signal from a host 20. The external signal may include an image signal and a reference signal. The reference signal may be a signal synchronized with a frame frequency. For example, the reference signal may include a vertical synchronization signal or a horizontal synchronization signal. The timing controller 12 may convert the external signal to a gate control signal GCS and a data control signal DCS.

The timing controller 12 may output the gate control signal GCS to the gate driver 13. The timing controller 12 may output the data control signal DCS to the source driver 14. The timing controller 12 may control the gate driver 13 and the source driver 14 using the gate control signal GCS and the data control signal DCS.

The gate driver 13 may sequentially apply gate signals to the gate lines GL1 to GLn of the liquid crystal panel 11 in response to the gate control signal GCS from the timing controller 12. The source driver 14 may apply data signals to the data lines DL1 to DLm of the liquid crystal panel 11 in response to the data control signal DCS from the timing controller 12.

If the gate signals are sequentially applied to the gate lines GL1 to GLn from the gate driver 13, a data signal corresponding to a gate line supplied with the gate signal may be applied to the data lines DL1 to DLm from the source driver 14. A frame screen may be displayed by applying the gate signal to all gate lines sequentially during a frame.

For example, if a gate signal is applied to a selected gate line GL1, a thin film transistor connected with the gate line GL1 may be turned on (enabled) by the gate signal. If a data signal is applied to a data line DL1 connected to the enabled thin film transistor, a liquid crystal capacitor CLC may be charged by the data signal transferred via the enabled thin film transistor.

The liquid crystal capacitor CLC may be charged and discharged by the data signal according to iterative on-off operations of the thin film transistor. Optical transmittance of liquid crystals is controlled by a voltage charged at the liquid crystal capacitor CLC, so that the liquid crystal panel 11 is driven.

If an electric field is continuously applied to a liquid crystal in the same direction, the liquid crystal may be deteriorated due to a polarization phenomenon of liquid crystal molecules. The image quality may be lowered by movement of impurity ions included in the liquid crystals.

An inversion manner in which a polarity of a data voltage is periodically inverted may be used to reduce the above-described deterioration phenomenon. The inversion manner may include a frame inversion manner, a line inversion manner, a column inversion manner, a dot inversion manner, and so on. As appreciated by the present inventors, a hybrid of the above approach may also be used to control the image quality and power consumption.

When the liquid crystal display device 10 operates in the inversion manner, negative correlation may exist between the image quality and the power consumption. If the liquid crystal display device 10 operates in the inversion manner having the high image quality, the power consumption of the liquid crystal display device 10 may increase. On the other hand, if the liquid crystal display device 10 operates in the inversion manner having the low power consumption, the image quality of the liquid crystal display device 10 may decrease.

An inversion manner of the liquid crystal display device 10 of embodiments according to the inventive concept may be changed according to an external signal or a driving state. The external signal may include an image signal input from an external device. The liquid crystal display device 10 may satisfy both image quality and power consumption goals by controlling the inversion manner.

Also, as described above, the liquid crystal display device 10 of the inventive concept may use a hybrid inversion manner as an embodiment of the inversion manner. The hybrid inversion manner may operate flexibly with respect to desired image quality and power consumption.

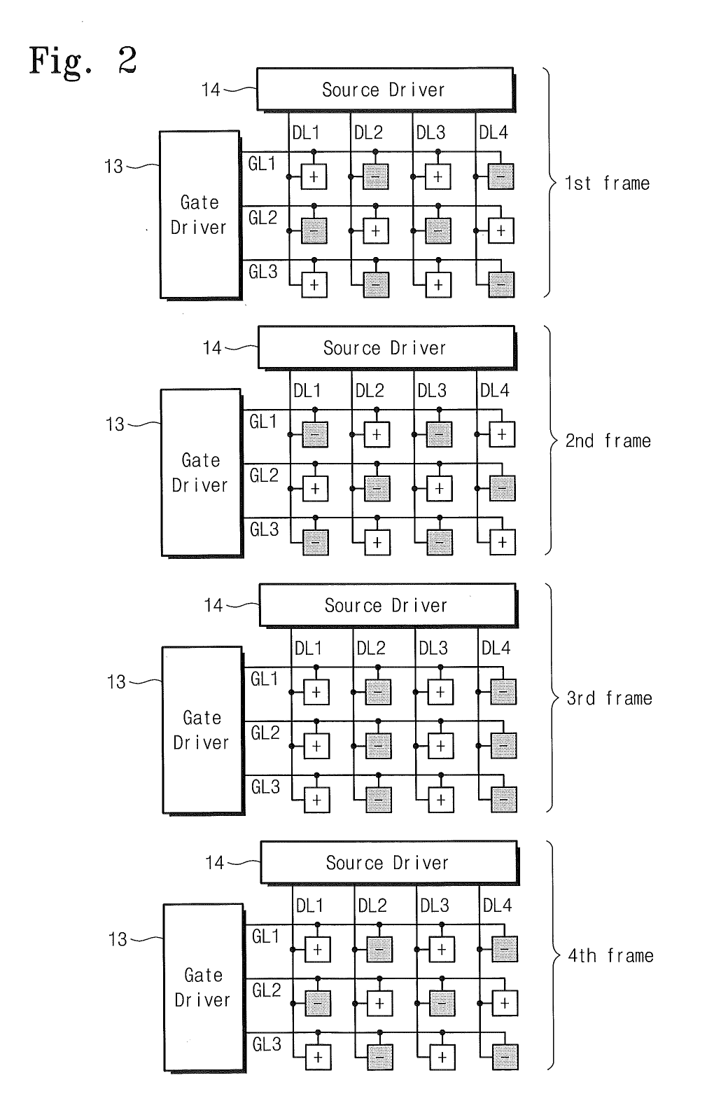

FIG. 2 is a diagram illustrating pixel polarities according to a hybrid inversion manner of the inventive concept.

For ease of description, it is assumed that a liquid crystal display device of FIG. 2 has a 3-by-4 matrix structure in which pixels are arranged in three gate lines GL1 to GL3 and four data lines DL1 and DL4. However, the inventive concept is not limited thereto.

In example embodiments, the liquid crystal display device driven in a hybrid inversion manner may be driven based on a first inversion manner. In the hybrid inversion manner, a second inversion manner frame may be inserted in a first inversion driving frame sequence driven in the first inversion manner with a predetermined frequency.

The first inversion manner may be an inversion manner of regarding the image quality as important. The liquid crystal display device driven in the first inversion manner may have large power consumption, while it may provide the excellent image quality.

The second inversion manner may be an inversion manner of regarding the power consumption as important. Power consumption of the liquid crystal display device driven in the second inversion manner may be lower than that in the first inversion manner, while the liquid crystal display device driven in the second inversion manner may provide a low image quality.

In example embodiments, a dot inversion manner may be used as the first inversion manner, and a column inversion manner may be used as the second inversion manner. However, the inventive concept is not limited thereto. For example, the first and second inversion manners may be a frame inversion manner or a line inversion manner.

The column inversion manner may be a manner in which polarities of data signals applied to pixels are equal in a vertical direction and polarities of data signals applied to pixels are opposite in a horizontal direction. In the column inversion manner, a polarity of a data signal may be changed every column, that is, every data line.

In the liquid crystal display device driven in the column inversion manner, since a polarity applied to a column is changed by the frame, deterioration of liquid crystals may be reduced. Also, since a voltage is switched by the column, power consumption may be reduced in comparison with a dot driving manner in which a voltage is switched by the pixel.

However, in the liquid crystal display device driven in the column inversion manner, pixels in the same column may have the same polarity. A flicker phenomenon and a coupling phenomenon may be generated between pixels in the column having the same polarity. Thus, the image quality of the liquid crystal display device driven in the column inversion manner may be lower than that of a liquid crystal display device driven in the dot driving manner.

A dot inversion manner may be a manner in which data signals are applied such that polarities of data signals applied adjacent pixels are opposite to one another (in both the row and column directions). In the dot inversion manner, polarities of data signals may be changed every data line and gate line.

In case of the liquid crystal display device driven in the dot inversion manner, since a polarity applied to a pixel is changed by the frame, deterioration of liquid crystals may be reduced. Since polarities of adjacent pixels are opposite, a flicker phenomenon and a coupling phenomenon may compensate for each other. Thus, the liquid crystal display device driven in the dot inversion manner may have the higher image quality compared with that driven in the column inversion manner. However, a switching number used for frame-per-voltage inversion in the liquid crystal display device driven in the dot inversion manner may increase compared with that driven in the column inversion manner. Thus, power consumption of the liquid crystal display device may increase.

As described above, a liquid crystal display device driven in the hybrid inversion manner may be driven based on a first inversion manner. In the hybrid inversion manner, a second inversion manner frame may be inserted in a first inversion driving frame sequence driven in the first inversion manner with a predetermined frequency. Thus, the image quality of the liquid crystal display device driven in the hybrid inversion manner may be improved in comparison with that a liquid crystal display device driven in the dot inversion manner. Also, compared with a liquid crystal display device driven in the dot inversion manner, the power consumption of the liquid crystal display device driven in the hybrid inversion manner may be reduced.

Referring to FIG. 2, the liquid crystal display device of the inventive concept may be driven the same as the dot inversion manner for a first frame and a second frame. That is, adjacent pixels may be switched to have opposite polarities, and polarities of pixels may be inverted by the frame.

At a third frame, the liquid crystal display device of the inventive concept may be driven in the column inversion manner. At a fourth frame, the liquid crystal display device of the inventive concept may again be driven in the dot inversion manner. That is, the liquid crystal display device of the inventive concept may be driven in the column inversion manner, and a column inversion manner frame may be inserted by a three-frame unit.

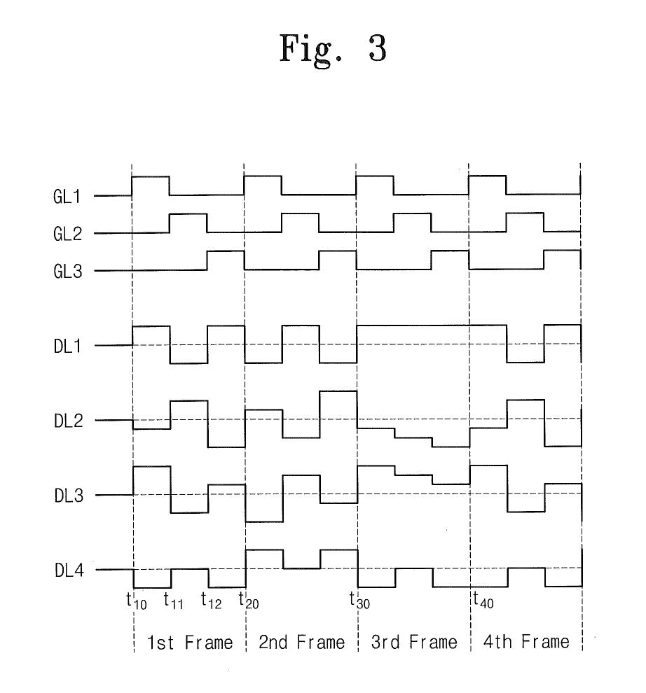

FIG. 3 is a timing diagram of gate and data signals applied to a liquid crystal display device of FIG. 2.

Referring to a first frame of FIG. 3, during a time period t₁₀ to t₁₁ when a gate signal is applied to a first gate line GL1, data voltages having a positive polarity may be applied to odd-numbered data lines DL1 and DL3. On the other hand, data voltages having a negative polarity may be applied to even-numbered data lines DL2 and DL4.

During a time period tᵢᵢ to t₁₂ when a gate signal is applied to a second gate line GL2, data voltages having a negative polarity may be applied to the odd-numbered data lines DL1 and DL3. On the other hand, data voltages having a positive polarity may be applied to the even-numbered data lines DL2 and DL4.

During a time period t₁₂ to t₂₀ when a gate signal is applied to a third gate line GL3, data voltages having a positive polarity may be applied to the odd-numbered data lines DL1 and DL3. On the other hand, data voltages having a negative polarity may be applied to the even-numbered data lines DL2 and DL4.

In case of the liquid crystal display device using the hybrid inversion manner, during the first frame, polarities of adjacent pixels (in the row and column directions) may be driven in different dot inversion manners.

The liquid crystal display device using the hybrid inversion manner may be driven in the dot inversion manner during a second frame. Thus, during a time period t₂₀ to t₃₀ when a gate signal is applied to each of the gate lines GL1 to GL3, data signals having an inverted version of polarities of the first frame may be applied to the data lines DL1 to DL4.

During a third frame, the liquid crystal display device using the hybrid inversion manner may be driven in a column inversion manner. That is, unlike the first and second frames, during a time period t₃₀ to t₄₀ when a gate signal is applied to each of the gate lines GL1 to GL3, data voltages having a positive polarity may be applied to the odd-numbered data lines DL1 and DL3 and data voltages having a negative polarity may be applied to the even-numbered data lines DL2 and DL4.

At a fourth frame, the liquid crystal display device using the hybrid inversion manner may be driven in the dot inversion manner. Thus, polarities of data voltages applied at the fourth frame may be the same as polarities of data voltages applied at the first frame.

A level of a charge voltage of a liquid crystal capacitor may be decided according to a level of a data voltage regardless of a polarity of the data voltage. That is, optical transmittance of pixels may be decided according to a level of the data voltage.

For example, it is assumed that a pixel connected with the first data line DL1 and the first gate line GL1 is referred to as a first pixel. Also, it is assumed that a pixel connected with the first data line DL1 and the second gate line GL2 is referred to as a second pixel. Referring to the first data line DL1 of FIG. 3, the first and second pixels may be supplied with data voltages which have the same level and opposite polarities. In this case, the first and second pixels may be supplied with data voltages having different polarities, while they may have the same optical transmittance.

The liquid crystal display device in embodiments according to the inventive concept may operate in a hybrid inversion manner in which a column inversion manner frame is inserted in a dot inversion manner frame sequence with a predetermined frequency. In example embodiments, a column inversion manner may be inserted by a three-frame unit (i.e., the third frame of the dot inversion sequence). However, the inventive concept is not limited thereto. In the hybrid inversion manner, a frequency where a second inversion manner frame is inserted may be variable, not fixed to a specific value.

Since the liquid crystal display device driven by hybrid inversion manner is driven based on a first inversion manner, it may have the high image quality. Also, since the liquid crystal display device driven by hybrid inversion manner uses a column inversion manner as a second inversion manner partially, power consumption of the liquid crystal display device driven by hybrid inversion manner may be reduced.

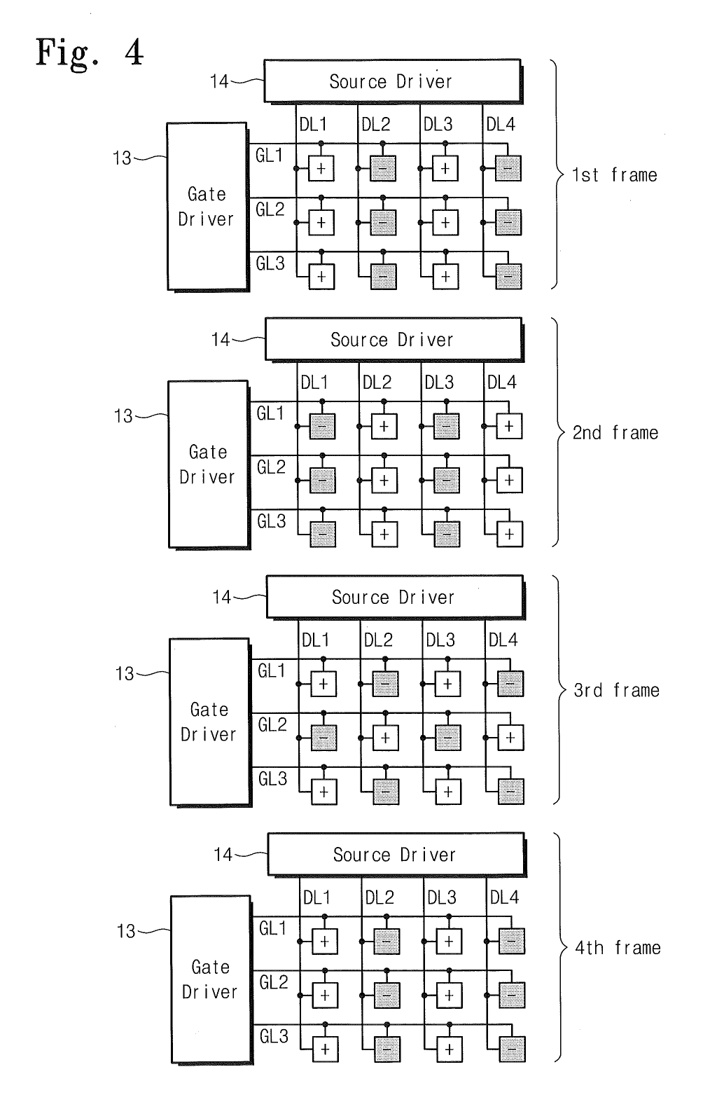

FIG. 4 is a diagram illustrating pixel polarities of a liquid crystal display device driven by a driving method according to another embodiment of the inventive concept.

For ease of description, it is assumed that a liquid crystal display device of FIG. 4 has a 3-by-4 matrix structure in which pixels are arranged in three gate lines GL1 to GL3 and four data lines DL1 and DL4. However, the inventive concept is not limited thereto.

The liquid crystal display device of the inventive concept may be driven based on a first inversion manner, and a second inversion manner frame may be inserted in a first inversion driving frame sequence driven in the first inversion manner with a predetermined frequency.

The first inversion manner may be an inversion manner wherein power consumption management is regarded as the objective. The liquid crystal display device driven in the first inversion manner may have less power consumption. The second inversion manner may be an inversion manner wherein management of the image quality is regarded as the objective. The liquid crystal display device driven in the second inversion manner may provide a higher image quality compared with that in the first inversion manner, while power consumption of the liquid crystal display device driven in the second inversion manner may be more than that in the first inversion manner.

In example embodiments, a column inversion manner may be used as the first inversion manner, and a dot inversion manner may be used as the second inversion manner. However, the inventive concept is not limited thereto. For example, the first and second inversion manners may be a frame inversion manner or a line inversion manner.

The liquid crystal display device using the hybrid inversion manner may be driven in the column inversion manner, and a dot inversion driving frame may be inserted in a column inversion driving frame sequence with a predetermined frequency. Thus, the liquid crystal display may provide a higher image quality compared with that in the column inversion manner, and may consume a less power compared with that in the dot inversion manner.

Referring to FIG. 4, the liquid crystal display device of the inventive concept may be driven the same as the column inversion manner during the first and second frames. That is, adjacent columns may have opposite polarities, and polarities of columns may be inverted every frame.

During a third frame, the liquid crystal display device of the inventive concept may be driven in the dot inversion manner. When an odd-numbered gate line is driven, a data voltage having a positive polarity may be applied to an odd-numbered data line and a data voltage having a negative polarity may be applied to an even-numbered data line. When an even-numbered gate line is driven, a data voltage having a negative polarity may be applied to an odd-numbered data line and a data voltage having a positive polarity may be applied to an even-numbered data line.

During a fourth frame, the liquid crystal display device of the inventive concept may again be driven in the column inversion manner. To be opposite to the second frame, a data signal having a positive polarity may be applied to an odd-numbered column and a data signal having a negative polarity may be applied to an even-numbered column. That is, during a time period when all gate lines are driven, odd-numbered data lines may have a positive polarity and even-numbered data lines may have a negative polarity.

The liquid crystal display device driven by the hybrid inversion manner may be driven based on the first inversion manner, so that power consumption is reduced. Also, since the liquid crystal display device utilizes a second inversion manner partially, the image quality may be improved.

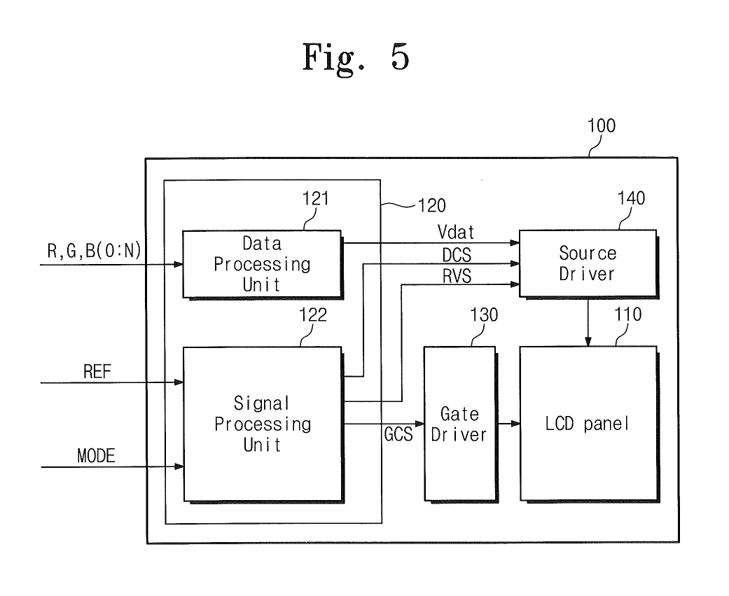

FIG. 5 is a block diagram schematically illustrating a liquid crystal display device 100 according to another embodiment of the inventive concept. Referring to FIG. 5, a liquid crystal display device 100 may include a liquid crystal panel 110, a timing controller 120, a gate driver 130, and a source driver 140.

The liquid crystal panel 110, the gate driver 130, and the source driver 140 of FIG. 5 may be configured substantially the same as a liquid crystal panel 11, gate driver 13, and source driver 14 of FIG. 1.

The liquid crystal display device 100 in some embodiments according to the inventive concept may change an inversion manner in response to a mode signal MODE. The liquid crystal display device 100 may provide reduced power consumption and image quality flexibly by changing the inversion manner according to the mode signal MODE.

The timing controller 120 may receive external signals. The external signal provided to the timing controller 120 may include an image signal R,G,B(0:N), a reference signal REF, and the mode signal MODE. The timing controller 120 may convert the external signals to generate image data Vdat, an inversion signal RVS, a gate control signal GCS, and a data control signal DCS.

The timing controller 120 may include a data processing unit 121 and a signal processing unit 122.

The data processing unit 121 may receive the image signal R,G,B(0:N) from a host 101. The data processing unit 121 may convert the image signal R,G,B(0:N) into the image data Vdat. The image data Vdat may be a signal obtained by sorting the image signal R,G,B(0:N) to be suitable to drive a liquid crystal panel. The data processing unit 121 may provide the image data Vdat to the source driver 140.

The signal processing unit 122 may receive the reference signal REF and the mode signal MODE from the host 101. The reference signal REF may be a signal synchronized with a frame frequency such as a vertical synchronization signal or a horizontal synchronization signal. The reference signal REF may be well known in the art.

The mode signal MODE may be a signal directing a driving mode of the liquid crystal display device 100. An inversion manner of the liquid crystal display device 100 may be decided according to the driving mode. In example embodiments, the driving mode of the liquid crystal display device 100 may include a first driving mode and a second driving mode.

The first driving mode may be a driving mode where management of the image quality is regarded as an objective. In example embodiments, the inversion manner of the liquid crystal display device 100 may be a dot inversion manner in the first driving mode. However, the inventive concept is not limited thereto.

The second driving mode may be a driving mode where management of the power consumption is regarded as an objective. In example embodiments, the inversion manner of the liquid crystal display device 100 may be a column inversion manner in the second driving mode. However, the inventive concept is not limited thereto.

The number of driving modes and inversion manners used is not limited by this disclosure. For example, three or more driving modes can be used. Also, the inversion manner may include a frame inversion manner, a line inversion manner, a hybrid inversion manner, and so on.

The signal processing unit 122 may generate the gate control signal GCS, the data control signal DCS, and the inversion signal RVS according to the reference signal REF and the mode signal MODE. The signal processing unit 122 may output the gate control signal GCS to the gate driver 13. The signal processing unit 122 may output the data control signal DCS and the inversion signal RVS to the source driver 140.

The inversion signal RVS may be a signal for inverting a polarity of a data voltage output from the source driver 140. A period and a pulse width of the inversion signal RVS may be determined based on a driving mode. For example, if a driving mode used at a current frame according to the driving mode is a dot inversion manner, the inversion signal RVS may be applied to the source driver 140 whenever a data voltage corresponding to a row of the current frame is applied.

That is, the signal processing unit 122 may control a polarity of a data voltage in an inversion manner corresponding to the mode signal MODE, using the inversion signal RVS. In the case that the mode signal MODE is changed, the signal processing unit 122 may change the inversion manner in synchronization with a frame. In this case, it is possible to reduce image artifacts during switching of the inversion manner.

When the mode signal MODE is changed, the signal processing unit 122 may change the inversion manner through dimming. With the dimming, a first inversion manner may be switched to a second inversion manner which may be gradually increase artifacts at a predetermined frame unit. It is possible to reduce an image from being displayed due to a sharp variation in the inversion manner. However, an inversion manner switching method of the signal processing unit 122 according to a variation in the mode signal MODE may not be limited to this disclosure.

The above liquid crystal display device 100 may change a driving mode according to the mode signal MODE. As the driving mode varies, an inversion manner of the liquid crystal display device 100 may vary. When an inversion manner of the liquid crystal display device 100 varies, the power consumption and image quality of the liquid crystal display device 100 may be controlled. The liquid crystal display device 100 may manage power consumption and image quality flexibly by changing the inversion manner according to the mode signal MODE.

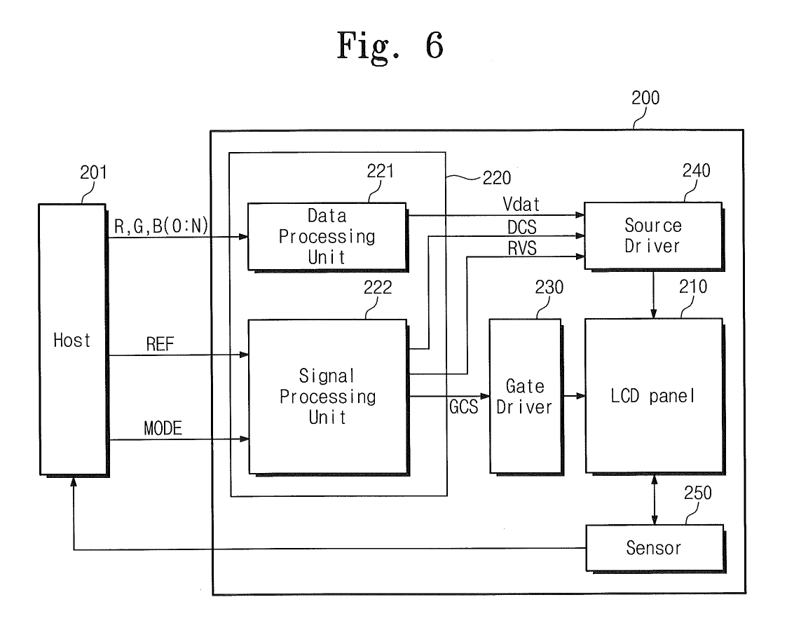

FIG. 6 is a block diagram schematically illustrating a liquid crystal display device 200 according to still another embodiment of the inventive concept. Referring to FIG. 6, a liquid crystal display device 200 may include a liquid crystal panel 210, a timing controller 220, a gate driver 230, a source driver (240), and a sensor 250.

The liquid crystal display device 200 of the inventive concept may change an inversion manner according to a driving state of the liquid crystal display device 200. The power consumption and image quality may be managed according to a driving state of the liquid crystal display device 200.

The sensor 250 may measure a driving state of the liquid crystal display device 200. A driving state measured by the sensor 250 may include the image quality of the liquid crystal panel 210 and the power consumption of the liquid crystal display device 200.

The image quality measured by the sensor 250 may be determined based of the brightness of each pixel. Also, the image quality measured by the sensor 250 may be decided by flicker level of the liquid crystal panel 210. However, the inventive concept is not limited thereto.

The sensor 250 may compare the measured image quality or the power consumption of the liquid crystal display device 200 with a predetermined value. The sensor 250 may provide a comparison to a host 201.

The host 201 may generate a mode signal MODE according to the comparison result provided from the sensor 250. The mode signal MODE may be transferred to the liquid crystal display device 200.

As described with reference to FIG. 5, an inversion driving method of the liquid crystal display device 200 may be changed according to the mode signal MODE. As described above, the mode signal MODE may be generated according to a comparison between a driving state of the liquid crystal display device 200 and a predetermined value. The liquid crystal display device 200 may manage power consumption and image quality by changing an inversion manner according to the mode signal MODE based on the comparison.

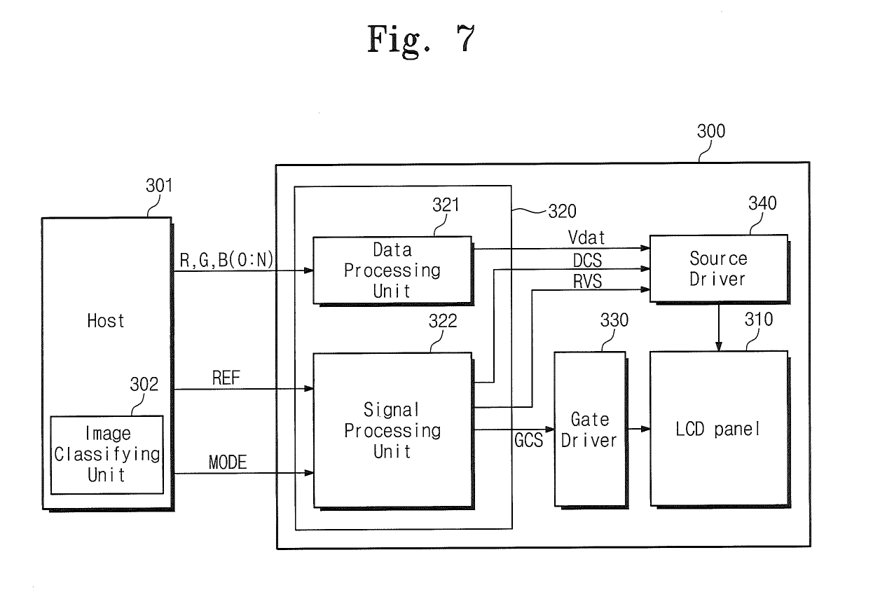

FIG. 7 is a block diagram schematically illustrating a host 301 connected with a liquid crystal display device 300 according to an embodiment of the inventive concept. Referring to FIG. 7, a host 301 may include an image classifying unit 302. A liquid crystal display device 300 of FIG. 7 may be configured the same as that 100 of FIG. 5, and a description thereof is thus omitted.

The host 301 of the inventive concept may generate a mode signal MODE based on an image signal transferred to the liquid crystal display device 300. Using the mode signal MODE, the host 301 may control an inversion manner of the liquid crystal display device 300 to correspond to how sensitive an image signal is to quality (i.e., quality sensitivity).

The image classifying unit 302 may classify an image signal to be sent to the liquid crystal display device 300. The image classifying unit 302 may classify the image signal to correspond to the quality sensitivity on an image signal. The quality sensitivity on an image signal may be decided by, for example, a contrast distribution of the image signal. The image classifying unit 302 may generate the mode signal MODE according to a classifying result on the image signal.

When an image signal sensitive to the image quality is transferred, the image classifying unit 302 may generate the mode signal MODE directing an inversion driving mode where higher image quality is desired. When an image signal insensitive to the image quality is transferred, the image classifying unit 302 may generate the mode signal MODE managing the inversion driving mode where lower power consumption is desired. The mode signal MODE generated from the image classifying unit 302 may be sent to the liquid crystal display device 300.

As described with reference to FIG. 5, an inversion manner of the liquid crystal display device 300 may be changed according to the mode signal MODE. The liquid crystal display device 300 may manage power consumption and image quality flexibly by changing an inversion manner according to the mode signal MODE.

As described above, the mode signal MODE may be generated according to the quality sensitivity on an image signal. The liquid crystal display device 300 may manage power consumption and image quality flexibly according to the quality sensitivity on an image signal.

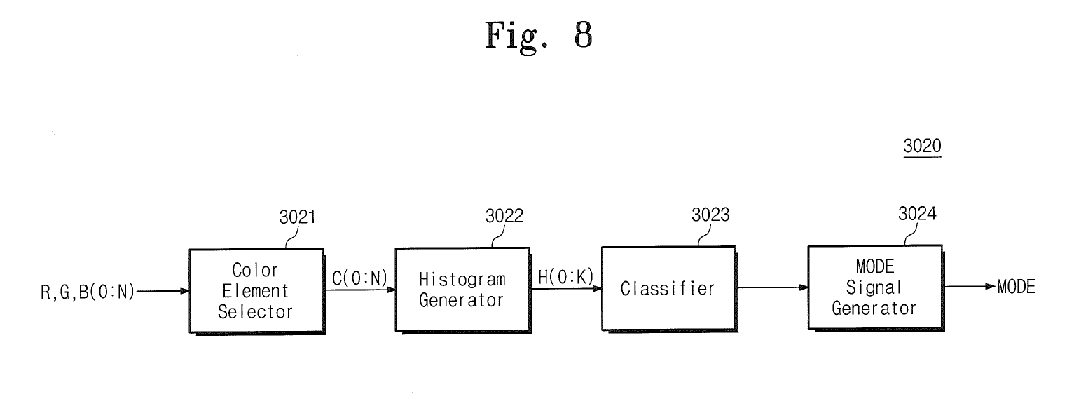

FIG. 8 is a block diagram schematically illustrating an image classifying unit according to an embodiment of the inventive concept. Referring to FIG. 8, an image classifying unit 3020 may include a color element selector 3021, a histogram generator 3022, a classifier 3023, and a mode signal generator 3024. The image classifying unit 3020 may classify an input image signal according to frame-per-contrast distribution to generate a mode signal MODE.

In FIG. 8, it is assumed that an image signal is an RGB color model signal. However, the inventive concept is not limited thereto. For example, an image signal can be an HSI or YCbCr color model signal or any other color value indication.

The color element selector 3021 may select a value of a specific color element from an input image signal R,G,B(0:N) to output it as a contrast signal C(0:N). For example, the color element selector 3021 may output a value of a color element, having the largest value, from among the input image signal R,G,B(0:N) as the contrast signal C(0:N). However, the inventive concept is not limited thereto. For example, the color element selector 3021 may determine the average of color element values of the input image signal R,G,B(0:N) to output it as the contrast signal C(0:N). Alternatively, the color element selector 3021 may calculate color element values of the input image signal R,G,B(0:N) using a weight to output it as the contrast signal C(0:N).

The histogram generator 3022 may receive the contrast signal C(0:N). The histogram generator 3022 may generate a histogram H(0:K) from the contrast signal C(0:N) by a frame unit. The histogram H(0:K) may indicate a contrast distribution of a frame having (K+1) contrast levels. The contrast level of the histogram may be expressed by the following equation.

$$H ( k ) = \frac{{n}_{k}}{( n + 1 )} \qquad ( 1 )$$

In the equation, k=0, . . . , K.

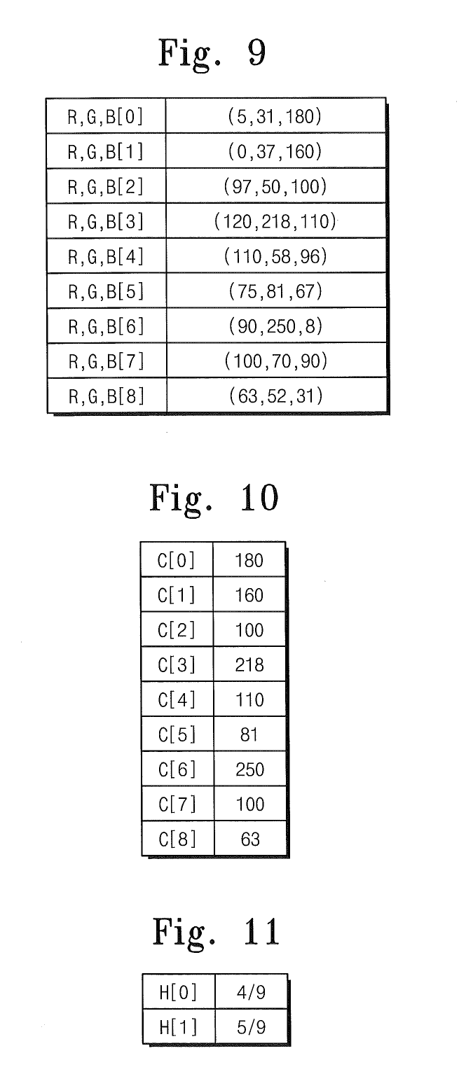

In the equation, “nₖ” may indicate the number of pixels corresponding to a contrast signal having a contrast level k. An operation of the histogram generator 3022 will be more fully described with reference to FIG. 9.

The classifier 3023 may classify an input frame in response to the histogram H(0:K). The classifier 3023 may classify the input frame according to the quality sensitivity in response to the histogram H(0:K). The classifier 3023 may store classification references corresponding to the histogram H(0:K) in a register.

The mode signal generator 3024 may generate a mode signal MODE based on a classifying result of the classifier 3023. The mode signal MODE may be a signal directing an inversion driving mode of a liquid crystal display device. The mode signal generator 3024 may output the mode signal MODE to the liquid crystal display device.

The above-described image classifying unit 3020 may generate a histogram from an input image signal by a frame unit. The image classifying unit 3020 may generate the mode signal MODE by classifying a frame according to the quality sensitivity based on the histogram. Since an inversion manner of the liquid crystal display device may be controlled by the mode signal MODE, it may provide the power consumption and image quality flexibly according to the quality sensitivity of an image signal.

FIGS. 9 to 11 are tables for describing an operation of the image classifying unit 3020 of FIG. 8. In FIGS. 9 to 11, a frame may be formed of nine pixels. However, the inventive concept is not limited thereto. In example embodiments, the number of pixels in a frame may not be limited.

FIG. 9 is a table illustrating an image signal R,G,B(0:8) of a frame.

The color element selector 3021 may receive an image signal R,G,B(0:8). An image signal R, G, B[n] corresponding to a pixel may include a red color element R, a green color element G, and a blue color element B. Each color element may have a value ranging from 0 to 255. A color of a pixel may be decided according to a value of each color element. The color element selector 3021 may select a value of a color element, having the largest value, from among an input image signal, and may output the selected color element value as a contrast signal.

FIG. 10 is a table illustrating a contrast signal C(0:8) generated from an image signal R,G,B(0:8) of FIG. 9. For example, since a color element, having the largest value, from among an image signal R,G,B(0) indicating a first pixel is a blue color element B, a value of a corresponding contrast signal C[0] may be a value of the blue color element B. Since a color element, having the largest value, from among an image signal R,G,B(8) indicating the final pixel is a red color element R, a value of a corresponding contrast signal C[8] may be a value of the red color element R.

FIG. 11 is a table illustrating a histogram H(0:1) generated from a contrast signal C(0:8) of FIG. 10. As illustrated in FIG. 11, the histogram generator 3022 may have two contrast levels. For example, in the case that a contrast signal has a value ranging from 0 to 255, the histogram generator 3022 may define a contrast ranging from 0 to 125 as a contrast level 0 and a contrast ranging from 126 to 255 as a contrast level 1. However, the inventive concept is not limited thereto. For example, the number of contrast levels and threshold values may not be limited to this disclosure.

In the contrast signal C(0:8), the number of pixels corresponding to the contrast level 0 may be 5 and the number of pixels corresponding to the contrast level 1 may be 4. With normalization, a value corresponding to the contrast level 0 may be 5/9, and a value corresponding to the contrast level 1 may be 4/9. Thus, a histogram H(0:1) generated from the contrast signal C(0:8) may be as illustrated in FIG. 11.

A classifier 3023 may classify an input frame in response to the histogram H(0:1). For example, the classifier 3023 may compare H[0] and H[1] to classify the frame. If a value of H[0] is larger, the frame may be classified into an image having a low contrast level. If a value of H[1] is larger, the frame may be classified into an image having a high contrast level. However, the inventive concept is not limited thereto. For example, the classifier 3023 may classify an image in various methods according to a distribution of a value of each contrast level, with respect to a histogram signal having three or more contrast levels.

A mode signal generator 3024 may generate a mode signal MODE based on a classification result of the classifier 3023. The mode signal generator 3024 may output the mode signal MODE to a liquid crystal display device.

In FIGS. 8 to 11, the image classifying unit 3020 may generate a histogram from an input image signal by a frame unit. The image classifying unit 3020 may generate a mode signal MODE by classifying a frame according to the quality sensitivity based on the histogram. Since an inversion manner of the liquid crystal display device can be controlled by the mode signal MODE, the liquid crystal display device may provide power consumption and image quality flexibly according to the quality sensitivity of an image signal.

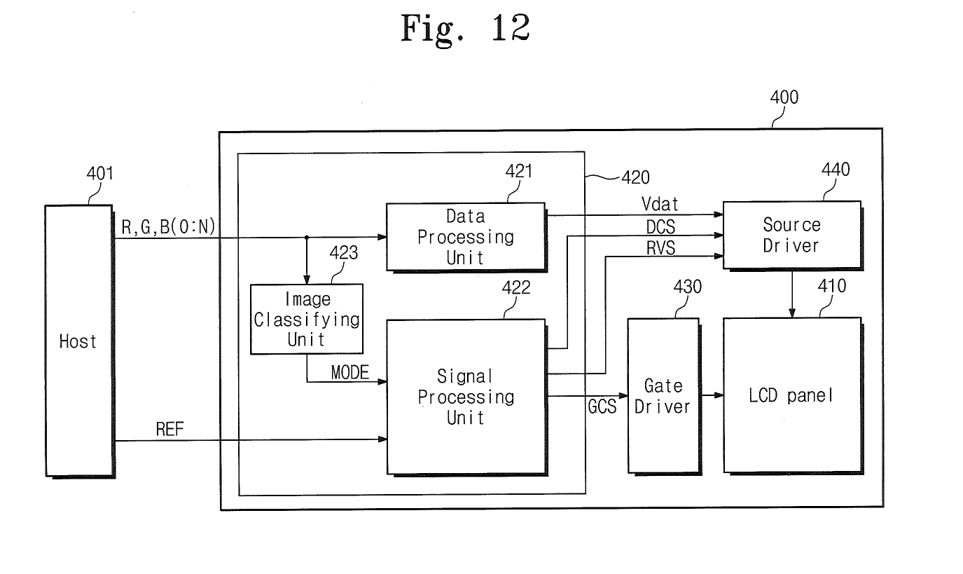

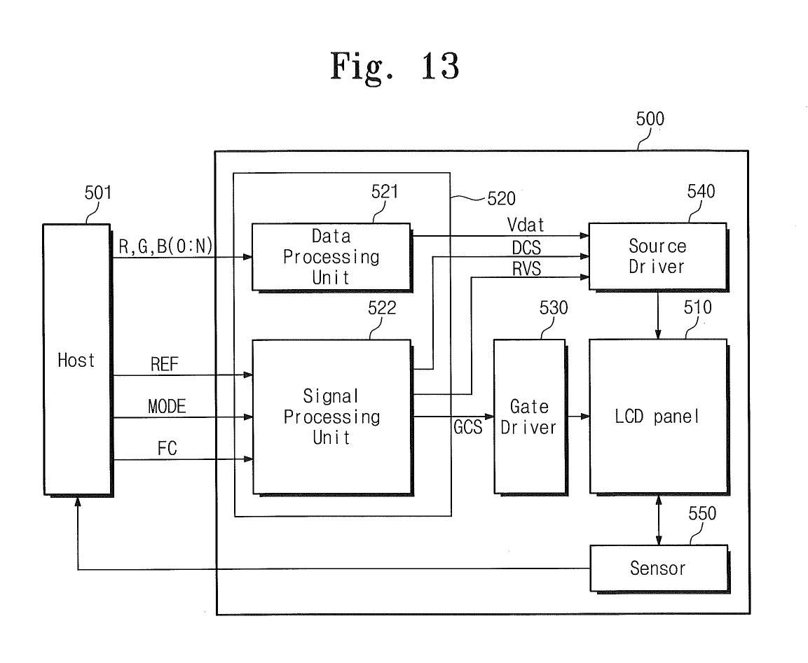

FIG. 12 is a block diagram schematically illustrating a liquid crystal display device 400 according to still another embodiment of the inventive concept. Referring to FIG. 12, the liquid crystal display device 400 may include a liquid crystal panel 410, a timing controller 420, a gate driver 430, and a source driver 440. The timing controller 420 may include a data processing unit 421, an image classifying unit 423, and a signal processing unit 422.

The liquid crystal display device 400 of FIG. 12 may be configured the same as a liquid crystal display device 100 of FIG. 5 except for the timing controller 420.

The data processing unit 421 may receive an image signal R,G,B(0:N) from a host 401. The data processing unit 421 may convert the image signal R,G,B(0:N) into an image data Vdat. The image data Vdat may be a signal obtained by sorting the image signal R,G,B(0:N) to be suitable to drive a liquid crystal panel. The data processing unit 421 may provide the image data Vdat to the source driver 440.

The image classifying unit 423 may classify the image signal R,G,B(0:N) provided from the host 401. The image classifying unit 423 may classify the image signal R,G,B(0:N) to correspond to the quality sensitivity on an image signal. The image classifying unit 423 may generate a mode signal MODE according to a classifying result on the image signal R,G,B(0:N). The image classifying unit 423 may transfer the mode signal MODE to the signal processing unit 422.

The signal processing unit 422 may receive a reference signal REF from the host 401. The signal processing unit 422 may receive the mode signal MODE from the image classifying unit 423. The reference signal REF may be a signal synchronized with a frame frequency such as a vertical synchronization signal or a horizontal synchronization signal.

The signal processing unit 422 may generate a gate control signal GCS, a data control signal DCS, and an inversion signal RVS according to the reference signal REF and the mode signal MODE. The signal processing unit 422 may output the gate control signal GCS to the gate driver 430. The signal processing unit 422 may output the data control signal DCS and the inversion signal RVS to the source driver 440.

The liquid crystal display device 400 of the inventive concept may change an inversion manner in response to the mode signal MODE. The liquid crystal display device 400 may manage power consumption and image quality flexibly by changing the inversion manner according to the mode signal MODE.

As described above, the mode signal MODE may be generated according to the quality sensitivity on an image signal. The liquid crystal display device 400 may manage power consumption and image quality flexibly according to the quality sensitivity on an image signal.

FIG. 13 is a block diagram schematically illustrating a liquid crystal display device 500 according to still another embodiment of the inventive concept. Referring to FIG. 13, the liquid crystal display device 500 may include a liquid crystal panel 510, a timing controller 520, a gate driver 530, a source driver 540, and a sensor 550.

The liquid crystal panel 510, the gate driver 530, and the source driver 540 of FIG. 13 may be configured the same as those elements shown in FIG. 6.

The liquid crystal display device 500 of the inventive concept may change an inversion manner according to a driving state of the liquid crystal display device 500. When the liquid crystal display device 500 is driven in a hybrid inversion manner, it may change a frequency for inserting a second inversion manner frame, that is, a hybrid frequency. The liquid crystal display device 500 may provide the power consumption and image quality flexibly by changing the hybrid frequency.

The timing controller 520 may receive external signals from a host 501. The external signal may include an image signal R,G,B(0:N), a reference signal REF, a frequency control signal FC, and a mode signal MODE. The timing controller 520 may convert the external signals to generate image data Vdat, an inversion signal RVS, a gate control signal GCS, and a data control signal DCS.

The signal processing unit 522 may receive the reference signal REF and the mode signal MODE from the host 501. When a driving mode directed by the mode signal MODE is a hybrid inversion manner, the signal processing unit 522 may receive the frequency control signal FC.

The mode signal MODE may be a signal directing a driving mode. The frequency control signal FC may be a signal for controlling the hybrid frequency of the liquid crystal display device 500. The hybrid frequency may be a frequency for inserting a frame driven in a second inversion manner at a driving mode in which the liquid crystal display device 500 is driven in a hybrid inversion manner.

The signal processing unit 522 may generate the gate control signal GCS and the data control signal DCS based on the reference signal REF, the frequency control signal FC, and the mode signal MODE.

The signal processing unit 522 may output the gate control signal GCS to the gate driver 530. The signal processing unit 522 may output the data control signal DCS to the source driver 540.

The sensor 550 may measure a driving state of the liquid crystal display device 500. A driving state measured by the sensor 550 may include the image quality of the liquid crystal panel 510 and the power consumption of the liquid crystal display device 500.

The sensor 550 may compare the measured image quality or the power consumption of the liquid crystal display device 500 with a predetermined value. The sensor 550 may provide a comparison thereof to the host 501.

The host 501 may generate the mode signal MODE. When a driving mode directed by the mode signal MODE is a hybrid inversion manner, the host 501 may change the frequency control signal FC and the mode signal MODE based on the comparison transferred from the sensor 550.

As the frequency control signal FC transferred from the host 501 to the timing controller 520 is changed, the hybrid frequency of the liquid crystal display device 500 may be changed. This operation may be repeated until a result satisfying a predetermined condition is obtained.

For example, at a mode where the low power consumption is regarded as an objective, the liquid crystal display device 500 and the host 501 may repeat the above-described operations until a predetermined power consumption condition is met. As the frequency control signal FC varies, the hybrid frequency of the liquid crystal display device 500 may gradually increase. A final hybrid frequency may be a frequency which satisfies the predetermined power consumption condition and meets the image quality objective.

Also, at a mode where the image quality is regarded as an objective, the liquid crystal display device 500 and the host 501 may repeat the above-described operations until a predetermined image quality condition is met. As the frequency control signal FC varies, the hybrid frequency of the liquid crystal display device 500 may gradually increase. A final hybrid frequency may be a frequency which satisfies the predetermined image quality condition and meets the power consumption objectives.

The above-described liquid crystal display device 500 may change a driving mode and a hybrid frequency according to the mode signal MODE and the frequency control signal FC transferred from the host 501. The host 501 may drive the liquid crystal display device 500 with the optimal hybrid frequency satisfying a predetermined condition by changing the frequency control signal FC through the sensor 550 and feedback of the signal processing unit 522.

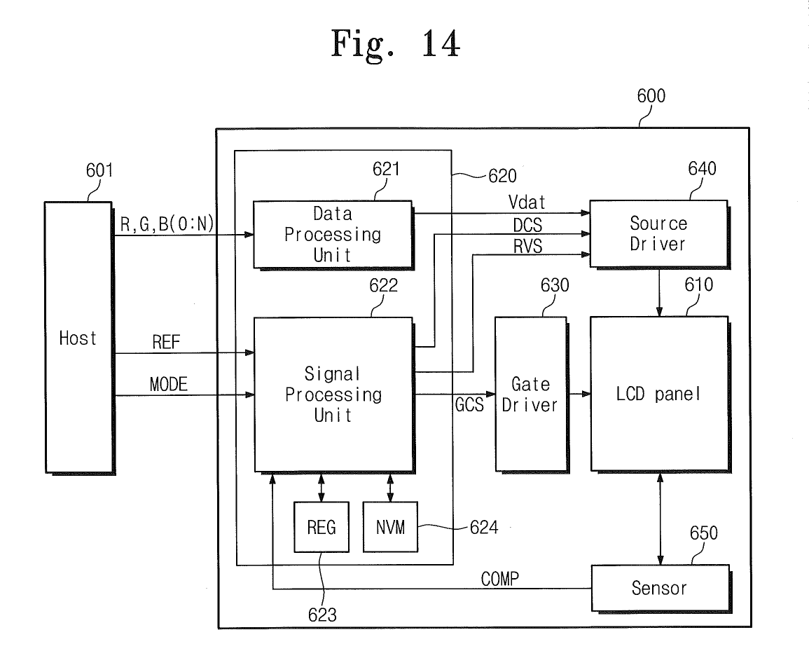

FIG. 14 is a block diagram schematically illustrating a liquid crystal display device 600 according to still another embodiment of the inventive concept. Referring to FIG. 14, the liquid crystal display device 600 may include a liquid crystal panel 610, a timing controller 620, a gate driver 630, a source driver 640, and sensor 650.

The liquid crystal panel 610, the gate driver 630, and the source driver 640 of FIG. 14 may be configured the same as those elements shown in FIG. 13.

The liquid crystal display device 600 of the inventive concept may change an inversion manner according to a driving state of the liquid crystal display device 600. When the liquid crystal display device 600 is driven in a hybrid inversion manner, it may change a frequency for inserting a second inversion manner frame, that is, a hybrid frequency. The liquid crystal display device 600 may provide the power consumption and image quality flexibly by changing the hybrid frequency.

The timing controller 620 may receive external signals from a host 601. The external signals may include an image signal R,G,B(0:N), a reference signal REF, and a mode signal MODE. The timing controller 620 may convert the input external signal to generate image data Vdat, an inversion signal RVS, a gate control signal GCS, and a data control signal DCS.

The timing controller 620 may include a data processing unit 621, a signal processing unit 622, and a register 623.

The data processing unit 621 may be configured the same as that of FIG. 13. The data processing unit 621 may receive an image signal R,G,B(0:N) from the host 601. The data processing unit 621 may convert the image signal R,G,B(0:N) into an image data Vdat. The data processing unit 621 may provide the image data Vdat to the source driver 640.

The signal processing unit 622 may receive the reference signal REF and the mode signal MODE from the host 601. The reference signal REF and the mode signal MODE may be substantially the same as described with reference to FIG. 13.

In the event that a driving mode directed by the mode signal MODE is a hybrid inversion manner, the signal processing unit 622 may load a hybrid frequency to be used for current driving of hybrid frequencies into the register 623. The signal processing unit 622 may generate the inversion signal RVS, the gate control signal GCS, and the data control signal DCS in response to the reference signal REF, the mode signal MODE, and the hybrid frequency stored in the register 623.

The signal processing unit 622 may output the gate control signal GCS to the gate driver 630. The signal processing unit 622 may output the data control signal DCS and the inversion signal to the source driver 640. The liquid crystal panel 610 may be controlled according to a signal output from the signal processing unit 622.

The sensor 650 may measure the image quality of the liquid crystal panel 610 or the power consumption of the liquid crystal display device 600. The sensor 650 may compare the measured image quality or the power consumption with a predetermined value. The sensor 650 may provide a comparison to the signal processing unit 622 as a comparison signal COMP. The sensor 650 may provide the comparison result to the host 601.

The signal processing unit 622 may change a hybrid frequency stored in the register 623 according to the comparison signal COMP transferred from the sensor 650. The above-description operations may be repeated until a result satisfying a condition is obtained.

For example, at a mode where low power consumption is regarded as an objective, the liquid crystal display device 600 may repeat the above-described operation until a predetermined power consumption condition is satisfied. The signal processing unit 622 may load a gradually increasing hybrid frequency from the register 623 in response to the comparison signal COMP. A final hybrid frequency may be a frequency which satisfies the predetermined power consumption condition and indicates an image quality that meets the objectives.

Also, at a mode where the image quality is regarded as an objective, the liquid crystal display device 600 may repeat the above-described operations until a predetermined image quality condition is satisfied. The signal processing unit 622 may load gradually increasing a hybrid frequency from the register 623 in response to the comparison signal COMP. A final hybrid frequency may be a frequency which satisfies the predetermined image quality condition and indicates the lowest power consumption.

The timing controller 620 may further comprise a nonvolatile memory 624. If a condition corresponding to the comparison signal COMP is determined to be satisfied, the signal processing unit 622 may store a current driving hybrid frequency at the nonvolatile memory 624. The hybrid frequency stored at the nonvolatile memory 624 may be loaded and used as an initial value at next driving of the liquid crystal display device 600.

The host 601 may adjust the mode signal MODE in response to the comparison signal COMP transferred from the sensor 650. In this case, a driving mode of the liquid crystal display device 600 may be changed.

The above-described liquid crystal display device 600 may change a driving mode according to the mode signal MODE transferred from the host 601. When the liquid crystal display device 600 is driven in a hybrid inversion manner, it may be driven with the optimal hybrid frequency satisfying a predetermined condition by changing the loaded hybrid frequency through the sensor 650 and feedback of the signal processing unit 622.

The optimal hybrid frequency selected may be stored in the nonvolatile memory 624 to be continuously used. In this case, the liquid crystal display device of the inventive concept may provide images having the improved quality and low power consumption continuously.

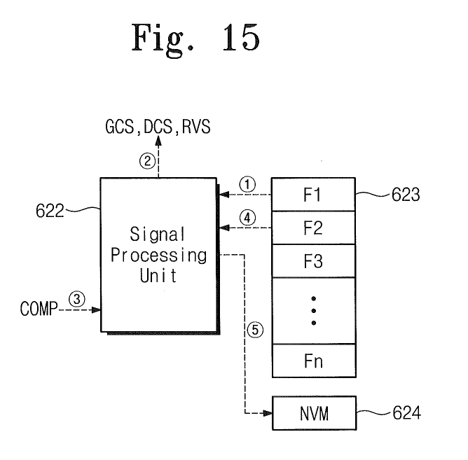

FIG. 15 is a diagram schematically illustrating a hybrid frequency loading and storing method of FIG. 14. A register 623 may be divided into a plurality of sectors. Predetermined hybrid frequencies F1 to Fn may be stored the sectors, respectively. A logical address of a sector may increase according to a level of a stored hybrid frequency. That is, a higher hybrid frequency may be stored at a sector having a greater logical address.

At a hybrid inversion manner, first, a signal processing unit 622 may load a hybrid frequency F1 stored at a sector having the smallest logical address (□). The signal processing unit 622 may output the gate control signal GCS, the data control signal DCS, and the inversion signal RVS in response to the loaded hybrid frequency and reference and mode signals REF and MODE from a host (□).

A liquid crystal panel may be driven according to the gate control signal GCS, the data control signal DCS, and the inversion signal RVS. A sensor may measure the image quality of the liquid crystal panel and the power consumption of a liquid crystal display device. The sensor may compare the measured value with a predetermined value to provide a comparison result to the signal processing unit 622 as a comparison signal COMP (□).

If the comparison signal COMP has a first state, the signal processing unit 622 may determine that a condition is not satisfied. The signal processing unit 622 may load a hybrid frequency F2 stored at a sector just adjacent to the sector where the hybrid frequency F1 is stored (□).

The signal processing unit 622 may output the gate control signal GCS, the data control signal DCS, and the inversion signal RVS newly in response to the newly loaded hybrid frequency and reference and mode signals REF and MODE from the host. The above-described operations may be repeated until the comparison signal COMP has a second state.

If the comparison signal COMP has the second state, the signal processing unit 622 may determine a condition to be satisfied. The signal processing unit 622 may retain the currently loaded hybrid frequency, and may output the gate control signal GCS, the data control signal DCS, and the inversion signal RVS. Also, the signal processing unit 622 may store the currently loaded hybrid frequency in the nonvolatile memory 624. The hybrid frequency stored in the nonvolatile memory 624 may be loaded and used as an initial value at next driving of the liquid crystal display device 600.

With the above-described hybrid frequency loading and storing method, hybrid frequencies may be sequentially loaded from a register according to the comparison signal COMP transferred from the sensor. However, the inventive concept is not limited thereto. For example, a method of selecting a hybrid frequency to be loaded from a register may be changed variously.

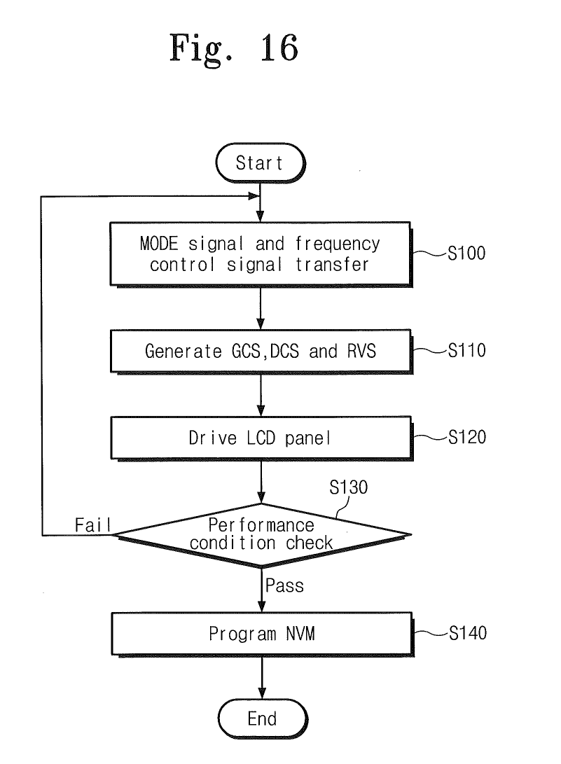

FIG. 16 is a flow chart illustrating a liquid crystal display device driving method according to an embodiment of the inventive concept.

In operation S100, a mode signal MODE may be transferred from a host to a timing controller. If a driving mode directed by the mode signal MODE is a hybrid inversion manner, a frequency control signal may be received from the host.

In operation S110, the timing controller may generate a gate control signal GCS, a data control signal DCS, and an inversion signal RVS in response to the mode signal and the frequency control signal. The timing controller may transfer the generated signals to a gate driver and a source driver.

In operation S120, a liquid crystal panel may be driven through the gate driver and the source driver according to the selected driving mode and hybrid frequency.

In operation S130, as the liquid crystal panel is driven, a sensor may measure a driving state, and may check whether the measured driving state satisfies a predetermined condition. The driving state measured by the sensor may be the image quality of the liquid crystal panel. Alternatively, the driving state measured by the sensor may be the power consumption of a liquid crystal display device.

The predetermined condition may be replaced with decision of a user. If the measured driving state does not satisfy the predetermined condition, the host may change the frequency control signal provided to the timing controller. The above-described operations may be repeated until the measured driving state satisfies the predetermined condition.

If the measured driving state satisfies a predetermined condition, in operation S140, the timing controller may store a current hybrid frequency used for driving at a nonvolatile memory. The hybrid frequency stored at the nonvolatile memory may be loaded and used as an initial value at next driving of the liquid crystal display device.

With the liquid crystal display device driving method, an inversion manner may be changed according to a mode signal. Also, at a hybrid inversion manner, a hybrid frequency may be changed until a predetermined driving state condition is satisfied.

Also, a hybrid frequency finally selected may be stored at the nonvolatile memory to be continuously used. In this case, the liquid crystal display device of the inventive concept may provide images having the improved quality and low power consumption continuously.

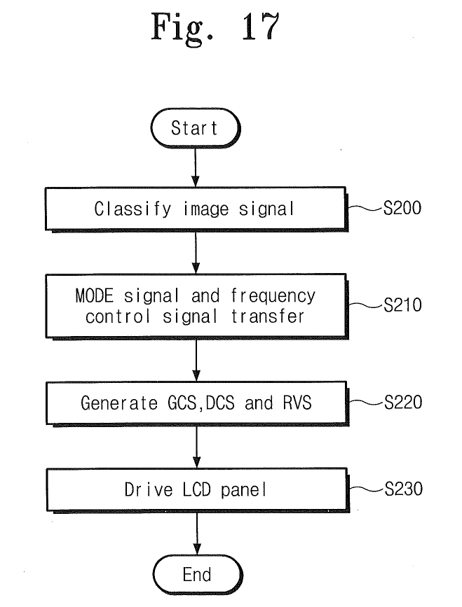

FIG. 17 is a flow chart illustrating a liquid crystal display device driving method according to another embodiment of the inventive concept.

In operation S200, an image signal may be classified. The image signal may be classified according to the quality sensitivity.

In operation S210, a host may output a mode signal to a timing controller according to the classifying result. Also, in the event that a driving mode directed by the mode signal is a hybrid inversion manner, the host may output a frequency control signal.

In operation S220, the timing controller may generate a gate control signal GCS, a data control signal DCS, and an inversion signal RVS in response to the mode signal and the frequency control signal. The timing controller may transfer the generated signals to a gate driver and a source driver.

In operation S230, a liquid crystal panel may be driven through the gate driver and the source driver according to the selected driving mode and hybrid frequency.

With the liquid crystal display device driving method, an inversion manner may be changed according to a classifying result of an image signal. Also, at a hybrid inversion manner, a hybrid frequency may be changed according to a classifying result of an image signal. That is, with the liquid crystal display device driving method, the liquid crystal display device of the inventive concept may provide images having the improved quality and low power consumption continuously in response to an image signal.

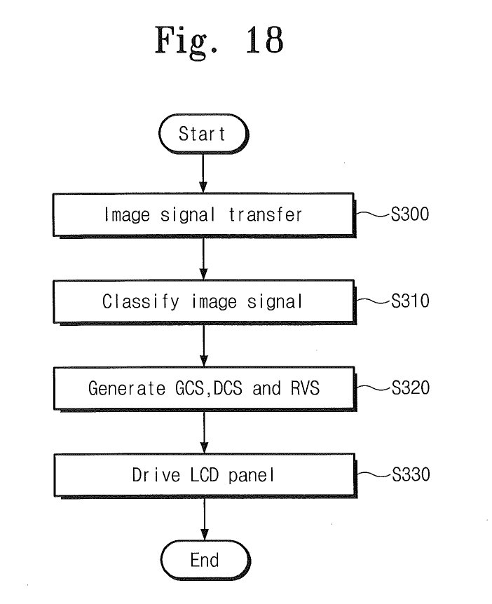

FIG. 18 is a flow chart illustrating a liquid crystal display device driving method according to still another embodiment of the inventive concept.

In operation S300, an image signal may be provided to a timing controller.

In operation S310, the input image signal may be classified. The image signal may be classified according to the quality sensitivity.

In operation S320, there may be generated a gate control signal GCS, a data control signal DCS, and an inversion signal RVS according to the classifying result. The timing controller may transfer the generated signals to a gate driver and a source driver.

In operation S330, a liquid crystal panel may be driven through the gate driver and the source driver according to the selected driving mode and hybrid frequency.

With the liquid crystal display device driving method, an inversion manner may be actively changed according to a classifying result of an image signal. That is, with the liquid crystal display device driving method, the liquid crystal display device of the inventive concept may provide images having the improved quality and low power consumption actively in response to an image signal.

The inventive concept may be modified or changed variously. For example, an image classifying unit, a timing controller, a gate driver, and a source driver may be changed or modified variously according to environment and use.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A liquid crystal display device comprising:
a gate driver configured to drive a gate line of a liquid crystal panel in response to a gate control signal;
a source driver configured to drive a data line of a liquid crystal panel in response to a data control signal; and
a timing controller configured to generate the gate control signal and the data control signal,
wherein the timing controller classifies an image signal and generates the gate control signal and the data control signal such that the liquid crystal panel is driven in an inversion manner corresponding to the classifying result.

2. The liquid crystal display device of claim 1, wherein the timing controller classifies the image signal according to a quality sensitivity of the image signal.

3. The liquid crystal display device of claim 1, wherein the timing controller generates a mode signal according to quality sensitivity of the image signal and selects an inversion manner of the liquid crystal panel in response to the mode signal.

4. The liquid crystal display device of claim 3, wherein when the mode signal is changed, the timing controller changes the inversion manner of the liquid crystal panel in synchronization with a frame.

5. The liquid crystal display device of claim 3, wherein when the mode signal is changed, the timing controller changes the inversion manner of the liquid crystal panel in a dimming manner.

6. The liquid crystal display device of claim 1, wherein an inversion manner corresponding to the classifying result of the image signal includes an inversion manner where a frame driven in a second inversion manner is inserted in a frame of the liquid crystal panel driven in a first inversion manner.

7. The liquid crystal display device of claim 6, wherein an insertion frequency of the frame driven in the second inversion manner is changed according to the classifying result of the image signal.

8. A liquid crystal display device driving method comprising:
classifying an image signal according to a quality sensitivity; and
changing an inversion manner of a liquid crystal panel according to the classifying result of the image signal.

9. The liquid crystal display device driving method of claim 8, further comprising:
allowing a host to generate a mode signal according to the classifying result of the image signal, and
wherein the changing an inversion manner of a liquid crystal panel according to the classifying result of the image signal includes changing an inversion manner of the liquid crystal panel according to the mode signal.

10. The liquid crystal display device driving method of claim 9, wherein an inversion manner of the liquid crystal panel includes an inversion manner where a frame driven in a second inversion manner is inserted in a frame of the liquid crystal panel driven in a first inversion manner, and an insertion frequency of the frame driven in the second inversion manner is changed according to the classifying result of the image signal.

11. A liquid crystal display device comprising:
a gate driver configured to drive a gate line of a liquid crystal panel in response to a gate control signal;
a source driver configured to drive a data line of a liquid crystal panel in response to a data control signal; and
a timing controller configured to generate the gate control signal and the data control signal,
wherein the timing controller controls the gate driver and the source driver through the gate control signal and the data control signal such that a frame driven in a second inversion manner is inserted in a frame of the liquid crystal panel driven in a first inversion manner.

12. The liquid crystal display device of claim 11, further comprising:
a sensor configured to measure a driving state and to compare the measured driving state with a predetermined condition to output a comparison signal,
wherein an insertion frequency of the frame driven in the second inversion manner is changed according to the comparison signal.

13. The liquid crystal display device of claim 12, wherein the timing controller comprises a register to store at least one or more hybrid frequencies, and wherein the timing controller selects one of the at least one or more hybrid frequencies to use the selected hybrid frequency as the insertion frequency.

14. The liquid crystal display device of claim 13, further comprising:
a nonvolatile memory, and
wherein the timing controller stores the selected hybrid frequency at the nonvolatile memory in response to the comparison signal.

15. The liquid crystal display device of claim 12, wherein the driving state corresponds to an image quality of the liquid crystal panel or a power consumption of the liquid crystal display device.

16. A liquid crystal display (LCD) device comprising:
a controller circuit configured to alternate between at least two different data inversion patterns each controlling data values provided to directly adjacent capacitors in an LCD panel,
wherein the least two different data inversion patterns comprise a first data inversion pattern and a second data inversion pattern each providing the different data values to the directly adjacent capacitors in an LCD panel, wherein the first data inversion pattern is used to drive a first number of frames of data to the LCD panel and the second data inversion pattern is used to drive at least one frame of data to the LCD between the first number of frames.

17. The LCD device of claim 16 wherein first data inversion pattern is configured to invert the data values provided to the directly adjacent capacitors in the LCD panel in both the row and column directions of the LCD panel and the second data inversion pattern is configured to invert the data values provided to capacitors that are in directly adjacent columns of the LCD panel.

18. The LCD device of claim 16 wherein at least one of the at least two different data inversion patterns is selected by a mode control signal provided by a host that is external to the controller circuit.

19. The LCD device of claim 18 wherein the mode control signal is configured to vary on a quality sensitivity of an image signal provided by the host.

20. The LCD device of claim 18 wherein the mode control signal is configured to vary based on a measured image quality of an image provided by the LCD panel.
